(19) United States
(12) Patent Application Publication
(10) Pub. No.: US 2002/0050715 A1
(43) Pub. Date: May 2, 2002

(54) Label with visible rear printing zone

(76) Inventor: Achille Elpidi, Milano (IT)

Correspondence Address: YOUNG & THOMPSON, 745 SOUTH 23RD STREET 2ND FLOOR, ARLINGTON, VA, 22202

(21) Appl. No.: 09/813,893

(22) Filed: Mar. 22, 2001

(30) Foreign Application Priority Data
Jul. 25, 2000 (IT) MI2000A 001703

(51) Int. Cl. B42D 15/00

(52) U.S. Cl. 283/81

(57) ABSTRACT

The label is designed to be applied to liquid containers of transparent material; the label comprises a large viewing opening or looking-through zone which allows one to see, through the transparent body of the container and a transparent liquid contained therein, designs, images, writing and/or illustrations reproduced in a printing zone on the rear side of the label adhering to the container, in a position facing the looking-through zone; the label may be made as one single piece or of several separate parts.

### BACKGROUND OF THE INVENTION

The present invention relates to improvements to labels for containers, bottles and the like and more precisely concerns a label especially designed to allow the viewing of writing and/or images and the displaying of messages and/or information reproduced on the back side of the label in zones which are normally not accessible or not legible when the label is applied to a container; the invention also relates to a container made of transparent material for a liquid which in turn has a certain transparency degree, provided with a label according to the invention.

In particular, the invention relates to a label made of paper sheet, plastic or the like, suitable for application to containers for storing liquid substances, having a body made of transparent material, such as, for example, glass or plastic bottles for alcoholic beverages such as grappa, gin, vodka, mineral water, soft-drinks and beverages of any type or kind, namely liquid substances in general provided that they have a certain degree of transparency required for the purposes of the present invention.

### PRIOR ART

The labels intended to be applied to bottles and/or containers generally consist of a paper sheet, plastic or the like having a substantially rectangular shape, the front side of which has printed or reproduced thereon, writing and/or designs relating to the bottled product or intended to embellish the container.

The label in general is applied to the external surface of the bottle or the container, by spreading a suitable adhesive on the rear side thereof or by means of heat-shrinking of the plastic from which the said label may be made.

Usually, a label of the conventional type has a printing surface provided with writing, designs and/or images on its front side, whereas the rear side of the label is entirely hidden or not visible, being solely intended to adhere to or be glued to the body of the container. All this constitutes a limitation in the use of conventional labels, which have the sole function of reproducing images and/or legible writing on the front side only, strictly related to the bottled product.

### OBJECTS OF THE INVENTION

The general object of the present invention is to provide an improved label, whereby it is possible to use the same label, in combination with a container onto which the label is applied, as a way and means for providing the consumer with further messages and/or information directly or indirectly relating to the bottled product, its geographical origin or derivation, for example by reproducing known locations, landscapes, monuments, works of art and/or public and private buildings, and also as a means for conveying related promotional and/or advertising messages and information, by means of a novel and original use of the label. In practice, the surface area used for illustrative or advertising purposes is nearly twice that of an usual label.

### BRIEF DESCRIPTION OF THE INVENTION

According to the invention a label made of paper sheet, plastic or the like, has been provided suitable for application to containers for liquid substances, having a body of transparent material, the bottled liquid in turn having a transparency degree, the label being in the form of an elongated sheet having a front side provided with a first printing zone for reproducing writing and/or illustrations, and a rear side intended to adhere to a peripheral wall of the container, characterized in that the label comprises at least one viewing opening, window, or looking through zone in a predefined position of the front side, and in that it comprises at least one second printing zone, for reproducing writing and/or designs and/or images on the rear side, said second printing zone being visible through said looking-through zone, when the label is wrapped around and made adhere to the body of the container, to allow the view of the printed matter on said second printing zone through the transparent body of the same container and a transparent liquid stored therein.

The novelty of the proposed solution here consists in the use of the rear side of a label, usually intended to be glued or fixed to the body of the container, as an additional printing surface, and in allowing the view of this rear printing surface by looking through a special opening window or transparent zone in the label, the transparent body of the container, and a transparent liquid bottled in the container, using the same transparent liquid inside the container as a magnifying glass which facilitates viewing and provides a panoramic effect, by imparting to the container a slight rotation or movement, while viewing an image through the looking-through zone as a result of the transparent effect.

According to a particular embodiment, the label with a looking-through zone according to the invention, is particularly suitable for application to transparent glass or plastic bottles for transparent liqueurs such as grappa, gin, vodka and the like, or for mineral water, not excluding transparent beverages of any type or kind, namely any liquid product provided it has a degree of transparency sufficient to allow viewing, through the container, of the writing and/or images reproduced on the printing zone at the rear side of the label.

According to the invention, the label is therefore suitable to perform, in addition to the usual function of ordinary embellishment of the container and/or illustration of the bottled product, a second function since it allows the displaying of additional messages and information relating directly or indirectly to the product, its geographical origin and/or derivation, or to provide additional messages for the purposes of promoting and/or advertising other products and/or other themes, all of which by means of an original viewing and communication effect.

The number, form, dimensions and arrangement of the openings or looking-through zone may be of any kind, provided that they are suitable for achieving the desired result.

Therefore, for the purposes of the present description, the terms “window” or “zone” are understood as meaning any opening formed in the label or any transparent surface area of the label having a transparent effect depending on the design features of the same label.

### BRIEF DESCRIPTION OF THE DRAWINGS

These and further features of a label according to the invention, will emerge more clearly from the description which follows, with reference to the example in the accompanying drawings, in which:

FIG. 1 is a front view of a label according to the invention;

FIG. 2 is a rear view of the label according to FIG. 1;

FIG. 3 is an enlarged cross-sectional view taken, along the line 3-3 of FIG. 1, showing two possible embodiments of a looking-through zone;

FIG. 4 is a cross-sectional view , similar to that of FIG. 3, showing a third embodiment of the viewing window;

FIG. 5 is a perspective view of the label in the condition when applied to a container.

### DETAILED DESCRIPTION OF THE INVENTION

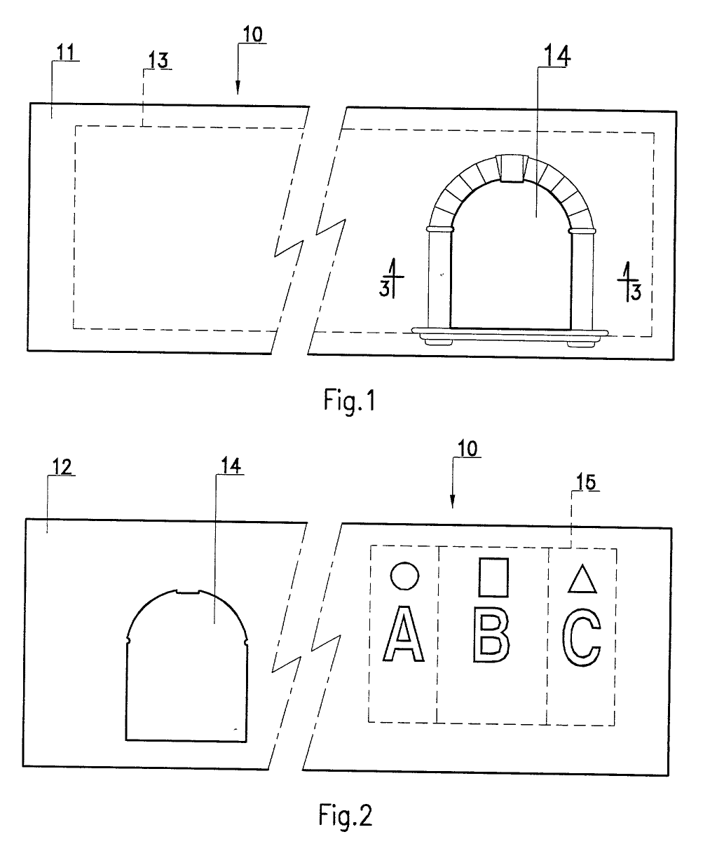

With reference to FIGS. 1 to 3, we shall describe a first embodiment of a label with a window or looking-through zone according to the invention.

As shown, the label, which is denoted overall by reference 10, substantially consists of a sheet of material of rectangular or of other suitable shape, having a front side 11 and a rear side 12 extending in a longitudinal direction.

The front side 11 of the label is also provided with a first printing zone 13 which may extend over part or the whole surface of the label and on which normally writing, designs or images typical for a bottled product are printed, in an entirely conventional manner; in the case of FIG. 1, the label 10 also comprises on one side, a large window 14 for the functions explained further below.

The window 14, as shown in FIGS. 1 to 3, may be in the form of a shaped opening obtained by die cutting the label during production, so as to allow viewing through the body of a transparent container (not shown) onto which the label is wrapped and applied, as described further below.

In the case of FIG. 1, the window 14 is shown in the form of an arched opening; however, it is possible to have other forms, shapes and/or dimensions for the window 14, and use several openings or windows of the same or different type for a same label.

Still according to the invention, the rear side 12 of the label, which is intended to be glued or adhered to the outer surface of a container, is provided, for example on one side of the window 14, with a second printing zone 15 for reproducing writing and/or designs and/or images showing for example famous places, landscapes, monuments, works of art and/or public or private buildings, as well as messages for promotional or advertising purposes, which can be viewed by looking through the window 14, the transparent body of the container and a transparent liquid substance contained therein, resulting in a suggestive visual effect as schematically shown in FIG. 5 of the accompanying drawings.

The extension, arrangement and dimensions of the rear printing zone 15 for reproducing writing and/or images on the back side 12 of the label, may be of any nature; in the case of FIG. 2 a single printing zone 15 has been provided on the rear side 12 of the label, since the viewing window 14 has been formed in the vicinity of one end of the label sheet; however, it is possible to have any other arrangement of the window 14 or one or more rear printing zones 15, which are spaced apart from each other and differently located with respect to the window 14.

In the example according to FIGS. 1 and 2, the label 10 is formed as one piece, although it is also possible to form the label as two or more parts, i.e. a front part provided with the window 14 and one or more rear parts each provided with a printing zone 15 on their back side intended to be fixed or glued to the container; moreover, in the example according to FIGS. 1 and 2, the window 14 is obtained by die cutting of the sheet material of the label 10.

In certain cases or for other applications, it may be convenient for the window 14 to be covered, by a transparent layer such that it is still possible to see through the window as described above.

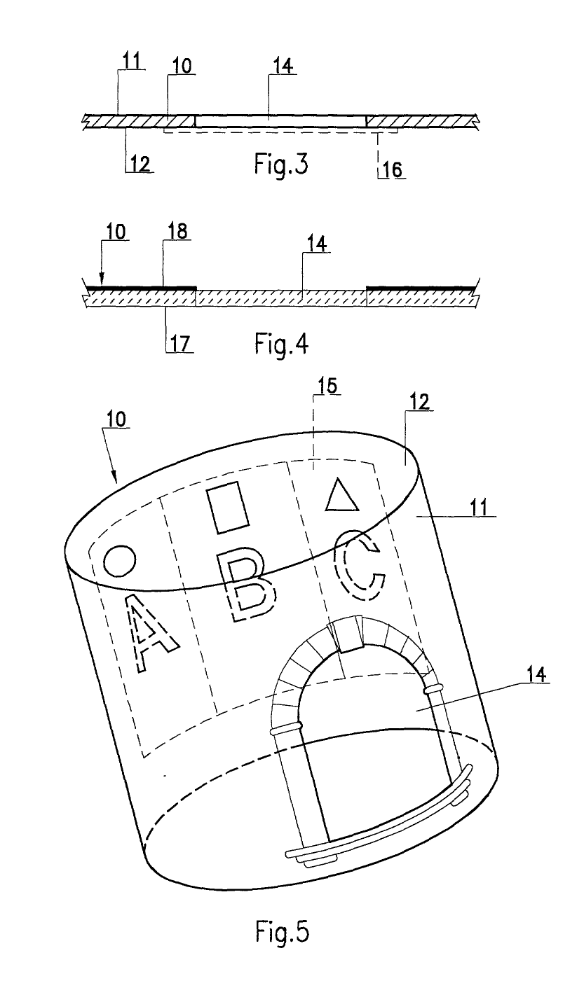

For this purpose, as schematically shown in broken lines in FIG. 3, the rear side 12 of the label may be provided with a sheet or a layer 16 of transparent material which closes the opening of the window while still making viewing possible.

FIG. 4 of the accompanying drawings shows a further possible embodiment; in this case the label 10 consists for example of a layered material comprising a back-layer 17 of transparent material, and a front non-transparent layer 18 which has been cut in the region of the window 14, or obtained by means overprinting with covering inks except for the zone of the front side of the label where the window 14 must be performed.

Obviously, within the scope of the present invention, other solutions are possible, for providing a transparent window, opening or zone which allows one to view, through the container and the liquid contained therein, the printing zone or zones 15 on the rear side of the label, once the latter has been applied and/or glued to a container.

All this may be better appreciated with reference to the perspective view of FIG. 5 which schematically shows the label according to FIGS. 1 and 2.

From FIG. 5 it can be seen, in fact, that when looking through the window 14, depending also on the viewing angle which may be varied by moving or orienting differently the container, it is possible to view the writing or graphic designs and/or messages present on the printing zone 15 which appears on the rear side of the label, in a position substantially opposite the viewing window.

From the description and explanations given it is therefore obvious that the invention has provided an improved label, which is able to perform additional functions compared to a conventional label and by means of which it is possible to obtain an effective visual effect which amplifies the messages and/or information displayed.

It is understood, however, that the description and explanations with reference to the accompanying drawings have been provided purely by way of example; therefore, other modifications or variations may be made both to the shape of label itself and to the form, arrangement and dimensions of the window and/or looking-through zone, without thereby departing from the scope of the appended claims.

What we claim is:

1. Label made of paper sheet, plastic or the like, suitable for application to containers for liquid substances, having a body of transparent material, the bottled liquid in turn having a transparency degree, the label being in the form of an elongated sheet having a front side provided with a first printing zone for reproducing writing and/or illustrations, and a rear side intended to adhere to a peripheral wall of the container, the label comprising at least one viewing opening, window, or looking through zone in a predefined position of the front side, and at least one second printing zone for reproducing writing and/or designs and/or images on the rear side, said second printing zone being visible from the front side through said looking-through zone, when the label is wrapped around and made adhere to the body of the container, to allow the view of the printed matter on said second printing zone through the transparent body of the same container and a transparent liquid stored therein.

2. Label according to claim 1, wherein the rear printing zone is laterally spaced and arranged on at least one side of the looking-through zone.

3. Label according to claim 1, wherein the same label consists of a single piece.

4. Label according to claim 1, wherein the label consists of at least two separate parts, comprising a front part provided with a looking-through zone, and at least one rear part having a second printing zone on the back side intended to adhere to the container.

5. Label according to claim 1, wherein the looking-through zone consists of an opening.

6. Label according to claim 5, wherein said looking-through zone is closed by a layer of transparent material.

7. Label according to claim 1, comprising a backlayer of transparent material, and a front layer of opaque material.

8. Label for a bottle or container according to claim 1, wherein said second printing zone comprises writing, designs, images and illustrations of landscapes, monuments, works of art and buildings, relating to a geographical origin and/or derivation of the stored product, which may be observed through the looking-through zone.

9. Label according to claim 1, wherein said second printing zone on the rear side comprises promotional and/advertising messages and information relating to products belonging to a same or to different manufacturers.

10. An assembly of a label and a transparent container for storing a transparent liquid, the label comprising an elongated sheet having a front side provided with a first printing zone for reproducing writing and/or illustrations, and a rear side intended to adhere to a peripheral wall of the container, at least one viewing opening, window, or looking through zone in a redefined position of the front side, and at least one second printing zone for reproducing writing and/or designs and/or images on the rear side, said second printing zone being visible from the front side through said looking-through zone, when the label is wrapped around and made adhere to the body of the container, to allow the view of the printed matter on said second printing zone through the transparent body of the same container and a transparent liquid stored therein.
